(19) United States
(12) Patent Application Publication
(10) Pub. No.: US 2010/0183153 A1
(43) Pub. Date: Jul. 22, 2010

(54) METHOD OF ESTABLISHING ROUTING PATH OF SENSOR NETWORK FOR IMPROVING SECURITY AND SENSOR NODE FOR IMPLEMENTING THE SAME

(75) Inventors: Tae Ho Cho, Gunpo-si (KR); Chung II Sun, Seoul (KR)

Correspondence Address: LEXYOUME IP GROUP, LLC, 5180 PARKSTONE DRIVE, SUITE 175, CHANTILLY, VA, 20151, US

(73) Assignee: SUNGKYUNKWAN UNIVERSITY FOUNDATION FOR CORPORATE COLLABORATION, Suwon-si (KR)

(21) Appl. No.: 12/372,085

(22) Filed: Feb. 17, 2009

(30) Foreign Application Priority Data
Jan. 22, 2009 (KR) 10-2009-0005457

(51) Int. Cl. H04L 9/06; H04W 40/02

(52) U.S. Cl. 380/277; 370/328

(57) ABSTRACT

Disclosed herein is a method of establishing the routing path of a sensor network and a sensor node for implementing the method. Each of a plurality of sensors belonging to a sensor network is assigned a key index and a key corresponding to the key index. The sensor node acquires information about key indices possessed by sensor nodes existing on a candidate routing path. The sensor node selects a final routing path from among a plurality of candidate routing paths using the information about the key indices. Accordingly, the present invention can implement a sensor network having improved security.

### CROSS-REFERENCE TO RELATED APPLICATION

This application claims priority to and the benefit of Korean Patent Application No. 10-2009-0005457 filed in the Korean Intellectual Property Office on Jan. 22, 2009, the entire contents of which are incorporated herein by reference.

### BACKGROUND OF THE INVENTION

1. Field of the Invention

The present invention relates to a method of establishing the routing path of a sensor network for improving security and a sensor node for implementing the method.

2. Description of the Related Art

A sensor network is a network configured such that sensor nodes widely distributed in three-dimensional space measure analog data, such as sound, light and motion in the three-dimensional space, and transfer the measured analog data to a central base station. Each sensor node may be generally configured to include a microcontroller, a memory unit, a sensor module, an output module, and a communication module. The sensor node having the above configuration converts analog data measured in physical space into digital data and transfers the digital data to a base station. Further, the base station, having received digital data from a plurality of sensor nodes, transmits the digital data to an external network, thus providing data about an event detected by a user or the like.

In this way, respective sensor nodes may transfer detected surrounding environment information to the base station, and the base station may provide relevant information to an external user through an existing communication network, such as the Internet. It is predicted that various applications will be realized through such a sensor network.

However, in order to configure a sensor network, a user distributes sensor nodes to desired regions from which information is to be obtained. Since the distributed sensor nodes are deployed in an open environment, they are vulnerable to physical attacks by attackers. Further, attackers may acquire security information such as an authentication key by capturing a sensor node, may generate a false report, containing false information, using the acquired authentication key, and may inject the false report into the sensor network through the compromised node captured by the attackers.

When such a false report is forwarded, there is a problem in that a base station may determine that an event, which did not actually occur, occurred due to the information contained in the false report, and may cause a so-called false alarm by which an alarm for the false report is provided to the user.

Further, sensor nodes existing on a routing path from the compromised node to the base station must forward the false report up to the base station. Therefore, there is a problem in that, when an attacker continuously generates a false report on purpose, the sensor nodes on the transfer path must perform a procedure for continuously forwarding the false report to the base station, and thus limited energy resources of the sensor nodes are consumed faster.

### SUMMARY OF THE INVENTION

Accordingly, the present invention has been made keeping in mind the above problems occurring in the prior art, and the present invention basically uses a path selection method based on statistical filtering which is one of possible security techniques. In detail, an object of the present invention is to provide a method of establishing the routing path of a sensor network and a sensor node for implementing the method, which evaluate routing paths that can be selected by respective sensor nodes using information about their own keys and select a routing path having the highest security level at the time of selecting a path, so that the probability of verification and dropping of false reports is increased, thus strengthening the security of a sensor network and saving the energy of sensor nodes.

In accordance with an aspect of the present invention, there is provided a method of establishing a routing path of a sensor network using a statistical filtering method, comprising the steps of each of a plurality of sensor nodes, belonging to the sensor network, being assigned a key index and a key corresponding to the key index; the sensor node acquiring information about key indices possessed by sensor nodes existing on a relevant candidate routing path; and the sensor node selecting a final routing path from among a plurality of candidate routing paths using the information about the key indices.

Preferably, the information about the key indices possessed by the sensor nodes existing on the routing path is information about a number of key indices unpossessed by at least one of other sensor nodes, from among a plurality of key indices possessed by a base station of the sensor network.

Preferably, the step of the sensor node selecting the final routing path using the information about the key indices is performed to select the final routing path by considering a number of key indices unpossessed by sensor nodes belonging to the plurality of candidate routing paths.

Preferably, the step of the sensor node selecting the final routing path using the information about the key indices is performed to select the final routing path by additionally considering a number of hops from the relevant sensor node to the base station.

Preferably, the step of the sensor node selecting the final routing path using the information about the key indices is performed to calculate a value of a security level function for at least one candidate routing path by the following equation, and to select a candidate routing path, having a minimum security level function value, as the final routing path,

Q(p)=D(p)+wP(p)

where p is an ID of a relevant candidate routing path, Q(p) is a security level function of path p, D(p) is a number of hops from the sensor node to the base station for path p, w is a security level constant, and P(p) is a number of key indices unpossessed by sensor nodes existing on the path p.

In accordance with another aspect of the present invention, there is provided a sensor node, comprising a security level function calculation unit for calculating a value of a security level function using information about key indices unpossessed by sensor nodes existing on a relevant candidate routing path corresponding to a received control message; a control message processing unit for generating a candidate routing path table including information about security level function values corresponding to respective sensor nodes which sent the control message; and a routing path selection unit for selecting a path, having a minimum security level function value from among a plurality of candidate routing paths included in the candidate routing path table, as a final routing path.

Preferably, the control message further includes information about a number of hops from the sensor node to the base station. Further, the security level function may be calculated by considering information about a number of hops from a relevant sensor node, which sent the control message, to the base station.

Preferably, the security level function calculation unit calculates the security level function value by the following equation,

Q(p)=D(p)+ωP(p)

where p is an ID of a relevant candidate routing path, Q(p) is a security level function of path p, D(p) is a number of hops from the sensor node to the base station for path p, w is a security level constant, and P(p) is a number of key indices unpossessed by sensor nodes existing on the path p.

Meanwhile, the control message processing unit increases the number of hops included in the received control message by 1, performs revision of marking a field corresponding to a key index possessed by the relevant sensor node, and broadcasts the revised control message.

Further, the sensor node further comprises a sensor unit for detecting whether an event has occurred around the sensor node; and an event processing unit for generating a report for the event when the sensor unit detects occurrence of the event, and forwarding the report along the final routing path.

In accordance with a further aspect of the present invention, there is provided a method of establishing a routing path of a sensor network, comprising the steps of a base station broadcasting a control message, which includes a plurality of key indices possessed by the base station, and check fields corresponding to the key indices; each of a plurality of sensor nodes generating a plurality of candidate routing paths using values of the check fields corresponding to the key indices, included in the control message when the control message is received, updating information of the received control message, and broadcasting the updated control message again; and the sensor node selecting a final routing path from among the plurality of candidate routing paths.

Preferably, the step of the sensor node selecting the final routing path from among the plurality of candidate routing paths is performed to select the final routing path by considering a number of key indices unpossessed by sensor nodes belonging to the plurality of candidate routing paths.

Preferably, the control message further includes information about a number of hops from the sensor node to the base station. The step of the sensor node selecting the final routing path is performed to select the final routing path by additionally considering the number of hops from the sensor node to the base station.

Preferably, the step of the sensor node selecting the final routing path is performed to calculate a value of a security level function for at least one candidate routing path by the following equation, and to select a candidate routing path, having a minimum security level function value, as the final routing path,

Q(p)=D(p)+wP(p)

where p is an ID of a relevant candidate routing path, Q(p) is a security level function of path p, D(p) is a number of hops from the sensor node to the base station for path p, w is a security level constant, and P(p) is a number of key indices unpossessed by sensor nodes existing on the path p.

Preferably, the revision of the control message is performed to increase the number of hops from a routing candidate sensor node to the base station by 1 and mark a check field corresponding to a key index included in the relevant sensor node.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of a sensor network according to an embodiment of the present invention;

FIG. 2 is a diagram showing a key assignment method for a sensor network required to use a statistical filtering method;

FIG. 3 is a diagram showing an example of the operation of a statistical filtering method using keys assigned in FIG. 2;

FIG. 4 is a diagram showing a procedure for dropping a false report currently being forwarded to a base station according to the statistical filtering method;

FIG. 5 is a flowchart showing a method of establishing the routing path of sensor nodes according to another embodiment of the present invention;

FIG. 6 is a diagram showing the configuration of a manipulation message used in the sensor network according to the present invention;

FIGS. 7A and 7B are diagrams showing a procedure for selecting a final routing path depending on a security level constant according to a further embodiment of the present invention; and

FIG. 8 is a diagram showing the construction of a sensor node according to yet another embodiment of the present invention.

### DESCRIPTION OF THE PREFERRED EMBODIMENTS

Hereinafter, embodiments of a method of establishing the routing path of a sensor network for improving security and a sensor node for implementing the method according to the present invention will be described in detail with reference to the attached drawings.

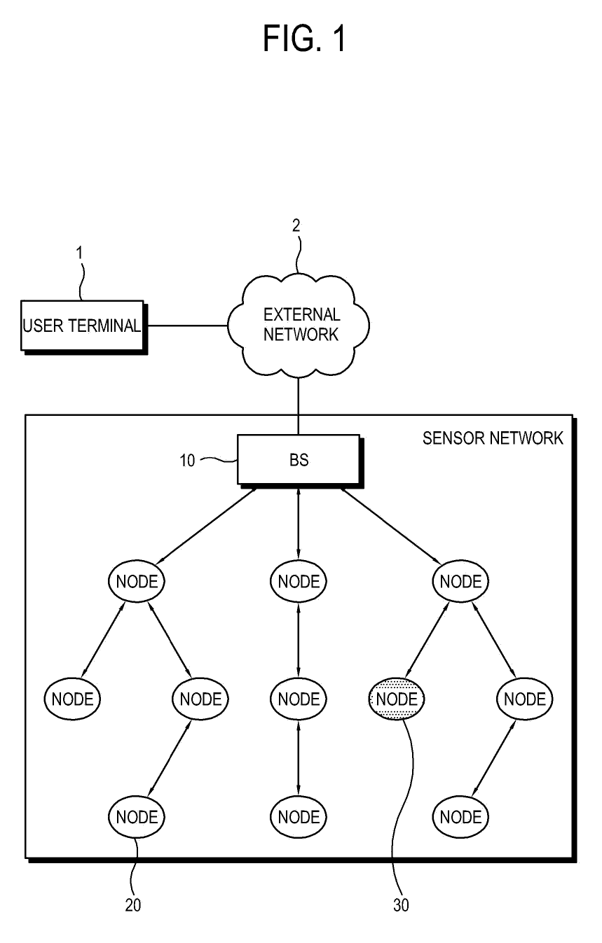

FIG. 1 is a diagram showing the construction of a sensor network according to an embodiment of the present invention.

As shown in FIG. 1, a wireless sensor network includes a Base Station (BS) 10 and a plurality of sensor nodes 20. Further, in order to expand the network, clusters may be formed using a clustering method.

The base station 10 is connected to a user terminal 1 through an external network 2, for example, a Local Area Network (LAN), the Internet, a wireless network such as Bluetooth, or a communication network using an artificial satellite or the like.

The user terminal 1 outputs and transfers information received from the sensor network to a user through application programs or other applications, and transfers control commands or data, determined on the basis of the received information by the user, to the base station 10. In particular, through the user terminal 1, a security level constant w, among security functions which will be described later, may be set.

Meanwhile, each of the sensor nodes 20 includes a sensor for detecting an event. Further, each sensor node 20 has limited energy resources, a limited wireless communication range, limited memory capacity and computing capability, etc. The sensor nodes 20, each having the above construction, are randomly distributed in the sensor network.

When an arbitrary event occurs in the sensor network, sensor nodes 20, detecting the event, report data related to the event (the type of event, and the time and place of the event occurrence) to the base station 10. Such event data reported in this way is called an event report, which is forwarded to the user terminal 1, thereby allowing the user to acquire information present in the sensor network.

Since the sensor nodes 20 are operated without being separately controlled by a user in an environment requiring unmanned monitoring, as in the case of a battlefield, they can very conveniently and efficiently observe an arbitrary place. However, from the standpoint of the fact that the sensor network is configured in a natural environment and an open and unmanned environment such as a battlefield, the following problems must be considered.

Since the sensor nodes 20 are randomly distributed in an unmanned environment, they have physical vulnerability. That is, an invader can physically compromise the sensor nodes 20.

A sensor node, compromised by an invader in this way, is called a compromised node 30. In FIG. 1, the compromised node 30 is represented by a shaded eclipse so as to be distinguishable from normal sensor nodes.

An invader may acquire information stored in the compromised node 30 from the compromised node 30. In particular, when the invader acquires a key related to the security of the sensor network from the compromised node 30, problems may be caused. The invader may generate a fabricated report (that is, a false report) using the acquired security key, and inject the fabricated report into the sensor network through the compromised node 30, thus causing the nodes in the sensor network and a network manager to fall into a state of disarray.

In order to solve the problems caused by the fabricated report generated by the invader, the present invention may use the following statistical filtering method.

Such a statistical filtering method is a technique configured such that, since the fabricated report is forwarded from the compromised node 30 to the base station 10, sensor nodes existing on such a routing path, that is, relay nodes, verify and drop the report with a predetermined probability. Hereinafter, the operation of the statistical filtering method is described in detail.

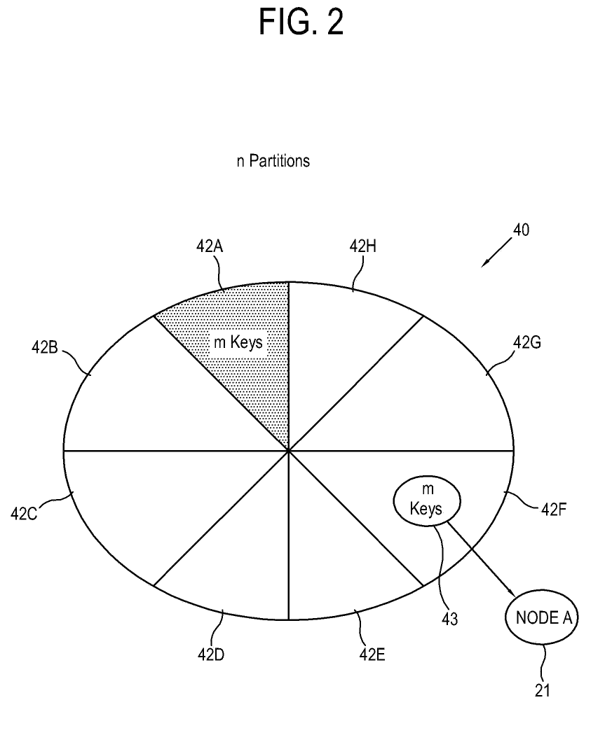

FIG. 2 is a diagram showing a key assignment method for the sensor network required to use the statistical filtering method.

The base station 10 has a global key pool 40 required to determine whether an event report has been fabricated.

The global key pool may be divided into n partitions 42A to 42H. In the embodiment of FIG. 2, the base station 10 has a global key pool composed of eight partitions 42A to 42H.

Each partition includes m keys and key indices corresponding to the keys. Here, n and m are arbitrary integers, which may be arbitrarily set by the manager of the sensor network or the like.

Before each of the sensor nodes 20 is randomly deployed, an arbitrary partition, among n partitions included in the global key pool 40, is assigned thereto. Of course, in one partition assigned to the sensor node 20, m keys and corresponding key indices are present.

In the embodiment of FIG. 2, a node A(21) is assigned a partition 42F included in the global key pool 40. The Node A(21) is also assigned both m keys 43 and corresponding key indices which belong to the partition 42F.

Through this procedure, each of the sensor nodes distributed in the sensor network is assigned both m keys and corresponding key indices which belong to the arbitrary partition.

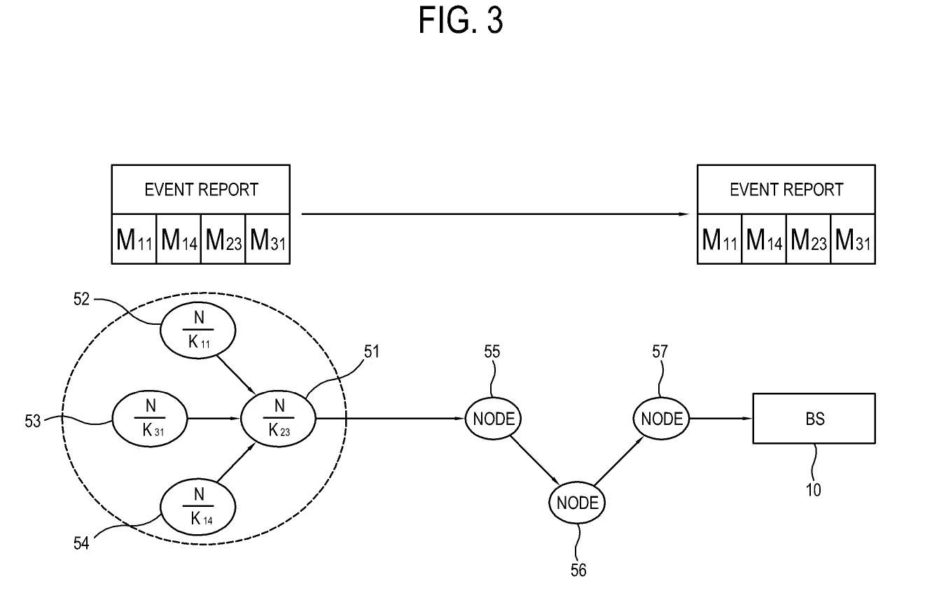

FIG. 3 is a diagram showing an example of the operation of a statistical filtering method using the keys assigned in FIG. 2.

After a plurality of sensor nodes has been distributed to arbitrary regions, they detect events using various sensors or the like.

In FIG. 3, each of sensor nodes 51, 52, 53 and 54, which detects an event, generates a Message Authentication Code (MAC) using event information (the type of event, the time and place of event occurrence, etc.) and some or all of its own keys.

Each of the sensor nodes 51, 52, 53 and 54, which generates the message authentication code, forwards both the event information and the message authentication code to a node having the highest event detection power (CoS: Center-of-Stimulus, hereinafter referred to as a ‘representative node’) 21. In the example of FIG. 3, the representative node is assumed to be the sensor node 51.

Referring to FIG. 3, the sensor nodes, which have detected the event, are represented by circles which are divided into upper and lower parts. Kₓ (x is an arbitrary natural number) is indicated in each lower half cycle and means that the sensor node includes a key index of Kₓ.

That is, referring to the event detection nodes 51, 52, 53 and 54, it can be seen that the representative node 51 stores a key index of K₂₃, and the sensor nodes 52, 53 and 54 store a key index of K₁₁, a key index of K₃₁, and a key index of K₁₄, respectively.

The nodes 52, 53 and 54, having detected the event, generate message authentication codes M₁₁, M₃₁ and M₁₄, respectively, using their own key indices, and send the message authentication codes, together with the event information, to the representative node 51. Of course, the representative node 51 itself generates a message authentication code M₂₃ using its own key index.

The representative node 51 receives the event information and the message authentication codes from the event detection nodes 51, 52, 53 and 54, and combines the received information together, thus generating a single event report.

That is, the representative node 51 generates the single event report by combining the message authentication code M₂₃ generated thereby and the message authentication codes M₁₁, M₃₁ and M₁₄ received from the nodes 52, 53 and 54, respectively, with each other. Of course, the event report also includes the event information as well as the message authentication codes M₁₁, M₁₄, M₂₃ and M₃₁.

The representative node 51 forwards the generated event report to the base station 10. In FIG. 3, on a path from the representative node 51 to the base station 10, sensor nodes 55, 56 and 57 for relaying the event report are present. Such sensor nodes are referred to as relay nodes 55, 56 and 57.

The relay nodes 55, 56 and 57 verify the event report with a predetermined probability, without unconditionally relaying the event report to the base station 10. For example, each of the relay nodes 55, 56 and 57 compares the key index corresponding to the message authentication code, included in the event report, with its own key index with a probability of 30%.

If the same key index as the key index of the relevant relay node itself is not included in the event report, the relay node cannot verify the event report, and thus forwards the event report to a subsequent relay node without change.

Further, if the same key index as the key index of the relevant relay node is included in the event report, the relay node independently generates a message authentication code using its own key index, and compares the generated message authentication code with the message authentication code included in the event report.

The case where the message authentication code generated using the key index of the relay node is identical to the message authentication code included in the event report indicates that the event report is a normal report. Therefore, the relay node forwards the event report to a subsequent relay node.

In contrast, the case where the message authentication code generated by the relay node using its own key index is different from that included in the event report indicates that the received report is a fabricated report. Therefore, the relay node drops the event report without forwarding the event report to a subsequent relay node.

Through the above-described statistical filtering method, the fabricated report may be dropped in advance by the relay nodes before it reaches the base station 10. As a result, energy of nodes consumed in verifying and forwarding a fabricated report between the sensor nodes and the base station can be reduced.

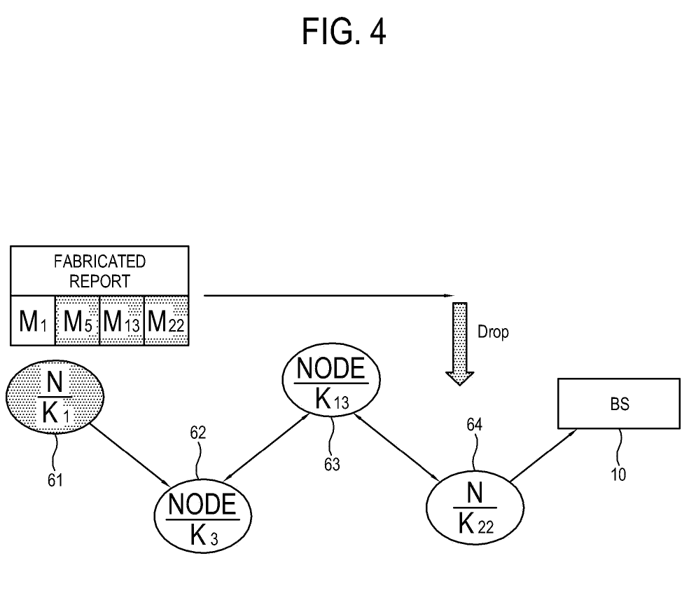

FIG. 4 is a diagram showing a procedure for dropping a fabricated report currently being forwarded to a base station according to the statistical filtering method.

In FIG. 4, a sensor node 61 is assumed to be a compromised node captured by an invader. Such a sensor node 61 is represented by a shaded circle.

The invader causes the compromised node 61 to generate a fabricated report indicating that an event has occurred. The compromised node 61 generates a message authentication code M₁ using a key index K₁ stored therein. In this case, the message authentication code M₁ is a code generated using a normal key.

However, the compromised node 61 inserts false message authentication codes M₅, M₁₃ and M₂₂ into an event report so as to generate the event report and routes the generated event report to the base station 10. Since the compromised node 61 does not know even the key indices of normal sensor nodes, the message authentication codes M₅, M₁₃ and M₂₂ are false codes. The falsely generated message authentication codes M₅, M₁₃ and M₂₂ are represented by shaded regions in order to be distinguishable from the normal message authentication code M₁.

During the relaying of the fabricated report to the base station 10, a verification operation is selectively performed by the relay nodes 62, 63 and 64 with a predetermined probability.

For example, the relay node 62 is a sensor node having a key index of K₃. Further, since the relay node 62 does not store the same key index as that present in the fabricated report, the relay node 62 forwards the fabricated report to the subsequent relay node 63 without verifying the fabricated report.

Meanwhile, the relay node 64 is a sensor node having a key index of K₂₂. It is assumed that the relay node 64 determines to verify the received event report. In this case, since the relay node 64 includes the key index of K₂₂, the verification of the event report is possible.

In this way, the operation of selectively verifying the report with a predetermined probability is performed.

The relay node 64 generates a message authentication code using its own key index K₂₂, and compares the generated message authentication code with the message authentication code M₂₂ present in the fabricated report, thus performing verification.

It is proved that the forwarded report is a fabricated report through the comparison between the generated message authentication code and the message authentication code present in the event report. The relay node 64 drops the fabricated report without relaying the fabricated report to the base station 10 (or a subsequent relay node).

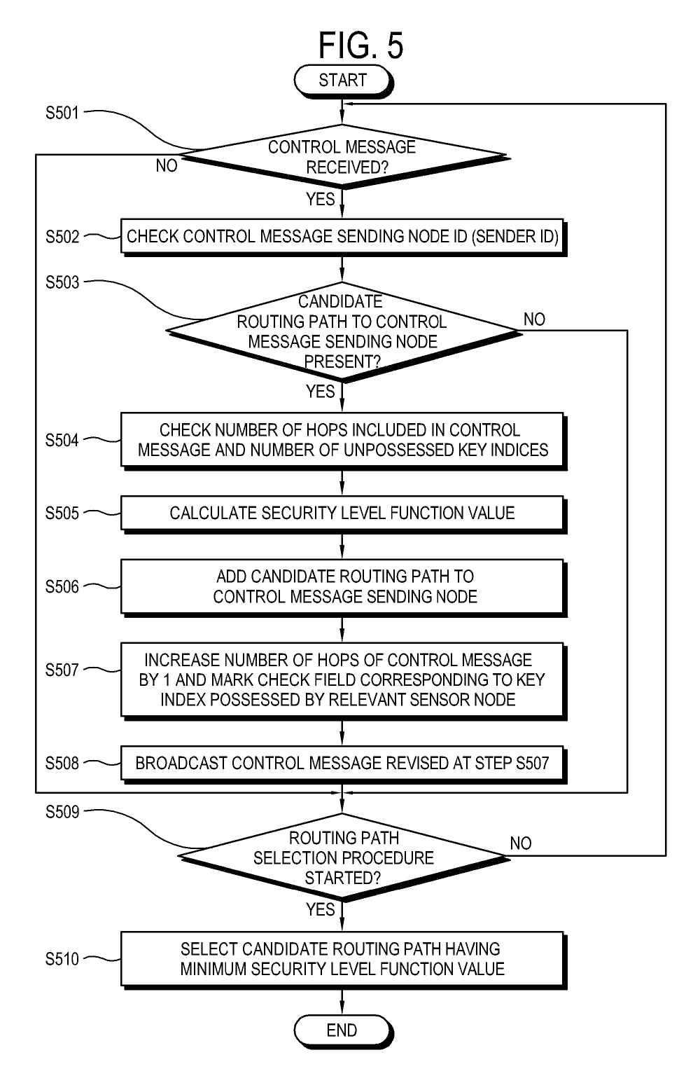

FIG. 5 is a flowchart showing a method of establishing the routing path of sensor nodes according to another embodiment of the present invention.

As described above with reference to FIG. 2, respective sensor nodes are assigned both key indices and keys corresponding to the key indices. After the key assignment procedure has been completed, the sensor nodes are randomly distributed to arbitrary regions in the sensor network. After the distribution of the sensor nodes, a procedure for establishing a routing path required to forward an event report to the base station is started.

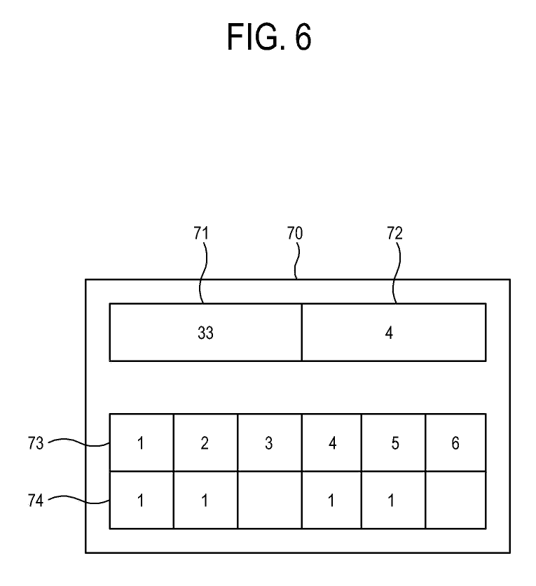

First, each sensor node determines whether a control message has been received from the base station or another sensor node at step S501. The control message will be described in detail with reference to FIG. 6.

FIG. 6 is a diagram showing the configuration of a control message used in a sensor network according to the present invention.

As shown in FIG. 6, a control message 70 includes a sender ID field 71 for indicating Identification (ID) of a sensor node, which sent the control message 70, a hop count field 72 for indicating the number of hops to the base station, key index fields 73 for indicating key indices possessed by the base station and check fields 74 corresponding to the respective key indices.

Preferably, the control message 70 further includes information about key indices possessed by the sensor node which sent the control message 70.

That is, the control message 70 includes a key index array composed of the key index fields 73 for indicating key indices possessed by the base station and the check fields 74 corresponding to the respective key indices.

The key index array 73 and 74 is used to indicate key indices included in one or more sensor nodes existing on the path along which the control message 70 is sent.

In the case where a check field is marked, this means that at least one sensor node existing on the path along which the control message is sent stores the marked key index. In contrast, when a check field is not marked, this means that a sensor node existing on the path along which the control message is sent does not have an unmarked key index.

For example, in the case of the control message 70 shown in FIG. 6, the ID of a sensor node which sent the control message 70 is 33. Further, it can be seen that the number of hops from the sensor node to the base station is 4.

In this embodiment, the case where the check fields of the key index array 73 and 74 have a value of “1” is assumed to be the case where the check fields are marked. In contrast, the case where the check fields are blank is assumed to be the case where the check fields are unmarked. Of course, the definition of marking can be freely changed.

In the embodiment of FIG. 6, key indices possessed by the sensor nodes existing on the path along which the control message 70 is sent are key indices 1, 2, 4 and 5. In contrast, key indices unpossessed by the sensor nodes existing on the path along which the control message 70 is sent are key indices 3 and 6.

Referring back to step S501, when a control message is not received, the sensor node proceeds to step S509, and thus determines whether to perform an operation of selecting a final routing path from among a plurality of candidate routing paths.

Meanwhile, the sensor node which received the control message at step S501 checks the sender ID of the control message, that is, the sender ID field 71 for indicating the ID of the sensor node which sent the control message in FIG. 6 at step S502. Thereafter, the sensor node determines whether a candidate routing path to the checked sensor node is present at step S503.

If it is determined at step S503 that the candidate routing path to the sensor node which sent the control message is present, the sensor node is found to have previously processed the control message received at step S501. Therefore, the sensor node proceeds to step S509 without performing other operations.

In contrast, if it is determined at step S503 that the candidate routing path to the ID of the sensor node which sent the control message is not present, the sensor node generates a new candidate routing path.

In detail, the sensor node checks the hop count field 72, and the key index array 73 and 74, that is, global key indices 73 and corresponding check fields 74, which are included in the control message 70, at step S504. Thereafter, the sensor node calculates the value of a security level function by applying the checked information to the following Equation (1) at step S505,

Q(p)=D(p)+wP(p) (1)

where p is a path, D(p) is the number of hops of the path p, and w is a security level constant which can be determined by a network manager. The security level constant is used to determine the current security level of the sensor network.

Further, P(p) is the number of indices, the check fields of which are unmarked in the key index array 73 and 74 received from the path p, that is, the number of key indices unpossessed by the sensor nodes existing on the path p.

As Q(p) calculated by Equation (1) becomes smaller, that is, as a security level function value becomes smaller, a path having Q(p) will have a higher security level, that is, more excellent security.

The sensor node generates a candidate routing path, including the ID of the sensor node which sent the control message 70, the number of hops, the number of unpossessed key indices, and the security level function value information, and adds the candidate routing path to the candidate routing path table at step S506.

For example, the sensor node which received the control message 70 of FIG. 6 may generate a candidate routing path having an ID value shown in the following Table 1.

TABLE 1

| | | | Number of | Security |
|---|---|---|---|---|
| | Neighboring | Hop | unpossessed key | level |
| Routing path ID | node ID | count | indices | (w = 0.25) |
| 1 | 33 | 4 | 2 | 4.50 |

The sensor node, having added the candidate routing path, revises information of the received control message 70 at step S507. In detail, the sensor node increases the number of hops (hop count) of the received control message by 1. Further, the sensor node performs revision of marking a check field corresponding to its own key index among the check fields corresponding to the respective key indices of the control message.

If the sensor node's own check field has already been marked, there is no need to revise the check field.

The sensor node broadcasts the revised control message to neighboring sensor nodes at step S508. That is, the sensor node revises information of the received control message and broadcasts the revised message to other sensor nodes.

The sensor node determines whether to perform an operation of establishing a final routing path by selecting one from among the plurality of candidate routing paths at step S509.

For example, when a preset period of time has elapsed or when a control message is not received within the preset period of time, the operation of establishing the final routing path may be performed. Further, the operation of establishing the final routing path may be performed after all sensor nodes have performed updating of the control message.

If it is determined that the operation of establishing the final routing path is not to be performed, the sensor node returns back to step S501, thus waiting for another control message to be received. When another control message is received, the sensor node has another candidate routing path.

If it is determined at step S509 that the operation of establishing the final routing path is to be performed, the sensor node does not receive control messages any more. The sensor node selects a candidate routing path having a minimum security level function value, from among the plurality of candidate routing paths stored in the candidate routing path table, as the final routing path at step S510.

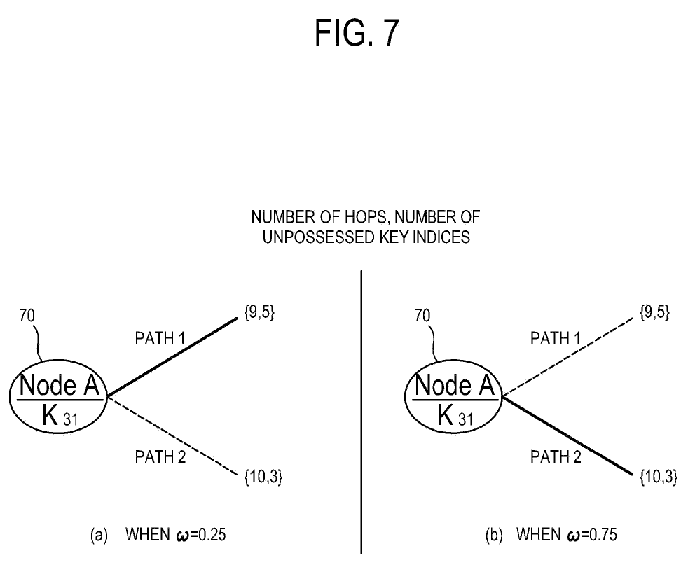

FIGS. 7A and 7B are diagrams showing a procedure for selecting a final routing path depending on a security level constant according to a further embodiment of the present invention.

As described above, each sensor node selects a path having a minimum security level function value from among the received paths as the final routing path. At this time, the sensor network manager adjusts a security level constant contained in the security level function, thus smoothly adjusting a security level.

In the embodiment of FIGS. 7A and 7B, methods of selecting two paths depending on security level constants of the network manager are shown.

Path 1 shows that the number of hops from node A (70) to the base station is 9 and the number of key indices unpossessed by the sensor nodes existing on the routing path is 5. Path 2 shows that the number of hops from the node A (70) to the base station is 10 and the number of key indices unpossessed by the sensor nodes existing on the routing path is 3 which is smaller than 5.

At this time, when the number of hops to the base station is considered, path 1 is more efficient than path 2 from the standpoint of energy consumption.

However, when the number of key indices unpossessed by the sensor nodes existing on the routing path is considered, path 2 has more excellent security than path 1. The reason for this is that the probability of path 2 not verifying an event report during the process for forwarding the event report to the base station is lower than that of path 1.

FIG. 7A illustrates the case where the network manager relatively decreases the security level of the network. For example, when a security level constant w is 0.25, the security level function value of path 1 becomes Q(path 1)=D(path 1)+w×P(path 1)=9+0.25×5=10.25. Further, the security level function value of path 2 becomes Q(path 2)=D (path 2)+w×P(path 2)=10+0.25×3=10.75. In this case, the sensor node selects path 1, having the minimum security level function value, as a routing path.

Meanwhile, FIG. 7B illustrates the case where the network manager increases the security level of the network. The network manager sets the security level constant w as 0.75.

The security level function value of path 1 becomes Q(path 1)=D(path 1)+w×P(path 1)=9+0.75×5=12.75. Further, the security level function value of path 2 becomes Q(path 2)=D(path 2)+w×P(path 2)=10+0.75×3=12.25. In this case, the sensor node selects path 2.

In this way, the security level constant is adjusted, and thus the security level of the sensor network can be flexibly adjusted. In particular, w=0 means that the user does not consider a security level at the time of establishing the routing path of the network.

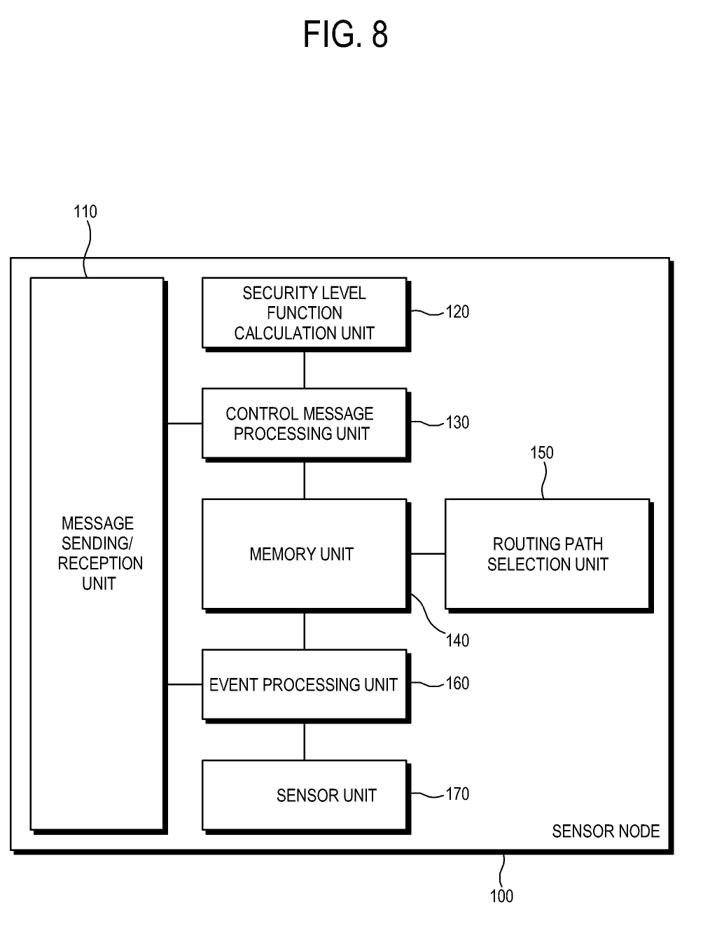

FIG. 8 is a diagram showing the construction of a sensor node according to yet another embodiment of the present invention.

As shown in FIG. 8, the sensor node may include a message sending/reception unit 110, a security level function calculation unit 120, a control message processing unit 130, a memory unit 140, a routing path selection unit 150, an event processing unit 160 and a sensor unit 170.

The message sending/reception unit 110 is a component for receiving a message from the base station or other sensor nodes. When receiving a control message, the message sending/reception unit 110 forwards it to the control message processing unit 130.

The control message processing unit 130 checks the sender ID included in the control message. Therefore, the control message processing unit 130 determines whether a candidate routing path to a sender node is present in a candidate routing path table stored in the memory unit 140 or the like.

If it is determined that the candidate routing path to the sender node is present, the control message processing unit 130 terminates processing on the control message. If it is determined that the candidate routing path to the sender node is not present, the control message processing unit 130 adds a new candidate routing path to the candidate routing path table through the following process.

The control message processing unit 130 checks information about the number of hops included in the control message. Further, the control message processing unit 130 checks the number of key indices, the check fields of which are unmarked. The control message processing unit 130 forwards information about the number of hops and the number of unmarked key indices, which have been checked, to the security level function calculation unit 120, thus enabling a security level function value to be calculated.

The security level function calculation unit 120 applies information about the number of hops and the number of unmarked key indices, which have been received from the control message processing unit 130, and a security level constant, which has been set by the network manager, to Equation (1), thus calculating the security level function value.

The control message processing unit 130 receives the security level function value back from the security level function calculation unit 120. Thereafter, the control message processing unit 130 stores the number of hops which is included in the control message, the number of key indices, the check fields of which are unmarked, and the security level function value, in the candidate routing path table of the memory unit 140.

Thereafter, the control message processing unit 130 increases the number of hops included in the received control message by 1 and performs revision of additionally marking a check field corresponding to a key index possessed by the relevant sensor node. The control message revised in this way is broadcasted through the message sending/reception unit 110.

Meanwhile, the routing path selection unit 150 selects one from among a plurality of candidate routing paths included in the candidate routing path table as a final routing path. The routing path selection unit 150 of the present invention establishes a candidate routing path having the minimum security level function value, from among the candidate routing paths, as the final routing path.

Meanwhile, after the final routing path has been established, the sensor unit 170 of the sensor node performs a detection procedure for detecting an event. When the sensor unit 170 of the sensor node detects an event, the event processing unit 160 of the sensor node generates an event report corresponding to the detected event. Thereafter, the event processing unit 160 forwards the generated event report along the finally selected routing path.

As described above, a method of establishing the routing path of a sensor network for improving security and a sensor node for implementing the method according to the present invention are advantageous in that a routing path is established in consideration of information about the number of unused key indices among the key indices of a base station, so that the verification of an event report can be performed with a higher probability than the case where an event report is subsequently routed. Further, there is another advantage in that a network operator can flexibly adjust the security of the sensor network through a security level constant that can be set by a user.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Therefore, the scope of the present invention should not be limited to the above embodiments and should be defined by the accompanying claims and equivalents thereof.

What is claimed is:

1. A method of establishing a routing path of a sensor network using a statistical filtering method, comprising the steps of:
each of a plurality of sensor nodes, belonging to the sensor network, being assigned a key index and a key corresponding to the key index;
the sensor node acquiring information about key indices possessed by sensor nodes existing on a relevant candidate routing path; and
the sensor node selecting a final routing path from among a plurality of candidate routing paths using the information about the key indices.

2. The method according to claim 1, wherein the information about the key indices possessed by the sensor nodes existing on the routing path is information about a number of key indices unpossessed by sensor nodes existing on the candidate routing path, from among a plurality of key indices possessed by a base station of the sensor network.

3. The method according to claim 2, wherein the step of the sensor node selecting the final routing path using the information about the key indices is performed to select the final routing path by considering the number of key indices unpossessed by sensor nodes belonging to the plurality of candidate routing paths.

4. The method according to claim 3, wherein the step of the sensor node selecting the final routing path using the information about the key indices is performed to select the final routing path by additionally considering a number of hops from the relevant sensor node to the base station.

5. The method according to claim 4, wherein the step of the sensor node selecting the final routing path using the information about the key indices is performed to calculate a value of a security level function for at least one candidate routing path by the following equation, and to select a candidate routing path, having a minimum security level function value, as the final routing path,
Q(p)=D(p)+wP(p)
where p is an ID of a relevant candidate routing path, Q(p) is a security level function of path p, D(p) is a number of hops from the sensor node to the base station for path p, w is a security level constant, and P(p) is a number of key indices unpossessed by sensor nodes existing on the path p.

6. A sensor node, comprising:
a security level function calculation unit for calculating a value of a security level function using information about key indices unpossessed by sensor nodes existing on a relevant candidate routing path corresponding to a received control message;
a control message processing unit for generating a candidate routing path table including information about security level function values corresponding to respective sensor nodes which sent the control message; and
a routing path selection unit for selecting a path, having a minimum security level function value from among a plurality of candidate routing paths included in the candidate routing path table, as a final routing path.

7. The sensor node according to claim 6, wherein the control message further includes information about a number of hops from the sensor node to the base station.

8. The sensor node according to claim 7, wherein the security level function is calculated by considering information about a number of hops from a relevant sensor node, which sent the control message, to the base station.

9. The sensor node according to claim 8, wherein the security level function calculation unit calculates the security level function value by the following equation,
Q(p)=D(p)+ωP(p)
where p is an ID of a relevant candidate routing path, Q(p) is a security level function of path p, D(p) is a number of hops from the sensor node to the base station for path p, w is a security level constant, and P(p) is a number of key indices unpossessed by sensor nodes existing on the path p.

10. The sensor node according to claim 6, wherein the control message processing unit increases the number of hops included in the received control message by 1, performs revision of marking a field corresponding to a key index possessed by the relevant sensor node, and broadcasts the revised control message.

11. The sensor node according to claim 6, further comprising:
a sensor unit for detecting whether an event has occurred around the sensor node; and
an event processing unit for generating a report for the event when the sensor unit detects occurrence of the event, and forwarding the report along the final routing path.

12. A method of establishing a routing path of a sensor network, comprising the steps of:
a base station broadcasting a control message, which includes a plurality of key indices possessed by the base station, and check fields corresponding to the key indices;
each of a plurality of sensor nodes generating a plurality of candidate routing paths using values of the check fields corresponding to the key indices, included in the control message when the control message is received, updating information of the received control message, and broadcasting the updated control message again; and
the sensor node selecting a final routing path from among the plurality of candidate routing paths.

13. The method according to claim 12, wherein the step of the sensor node selecting the final routing path from among the plurality of candidate routing paths is performed to select the final routing path by considering a number of key indices unpossessed by sensor nodes belonging to the plurality of candidate routing paths.

14. The method according to claim 13, wherein the control message further includes information about a number of hops from the sensor node to the base station.

15. The method according to claim 14, wherein the step of the sensor node selecting the final routing path is performed to select the final routing path by additionally considering the number of hops from the sensor node to the base station.

16. The method according to claim 15, wherein the step of the sensor node selecting the final routing path is performed to calculate a value of a security level function for at least one candidate routing path by the following equation, and to select a candidate routing path, having a minimum security level function value, as the final routing path,
Q(p)=D(p)+wP(p)
where p is an ID of a relevant candidate routing path, Q(p) is a security level function of path p, D(p) is a number of hops from the sensor node to the base station for path p, w is a security level constant, and P(p) is a number of key indices unpossessed by sensor nodes existing on the path p.

17. The method according to claim 16, wherein the revision of the control message is performed to increase the number of hops from a routing candidate sensor node to the base station by 1 and mark a check field corresponding to a key index included in the relevant sensor node.
